(19) United States
(12) Patent Application Publication
(10) Pub. No.: US 2022/0156388 A1
(43) Pub. Date: May 19, 2022

(54) DATA LEAK DETECTION USING SIMILARITY MAPPING

(71) Applicant: Microsoft Technology Licensing, LLC, Redmond, WA (US)

(72) Inventors: Maya KACZOROWSKI, San Francisco, CA (US); Pavel AVGUSTINOV, Milton (GB); Oege DE MOOR, San Francisco, CA (US); Sebastiaan Johannes VAN SCHAIK, Oxford (GB); Justin Allen HUTCHINGS, Issaquah, WA (US); Derek S. JEDAMSKI, Rochester, NY (US); Adam Philip BALDWIN, Pasco, WA (US)

(21) Appl. No.: 17/099,353

(22) Filed: Nov. 16, 2020

(51) Int. Cl. G06F 21/60; G06F 16/2458

(52) U.S. Cl. CPC G06F 21/604; G06F 16/2468

(57) ABSTRACT

The computer-performed automatic estimation of data leaks from private stores into public stores. The owner of the data in the private store can then be alerted to the estimation so the cause of such leaks can be remedied. The estimation is based on comparisons between similarity mapping results for data within the private store with similarity mapping results for data within the public store. As an example, the one-way similarity mapping could be a fuzzy hashing or a provenance signature.

### BACKGROUND

Quite often, individuals collaborate in order to author textual information stored in one of more files. Existing version control applications provide a distributed environment that tracks the history of changes made to the textual information by each individual. Existing version control applications even allow multiple individuals to work on the very same file at the same time. The applications merge any changes that can be consistently merged, and surface inconsistent changes to the individuals so they can decide which change to keep. One commonly used version control application is called “Git”. Furthermore, one type of textual information that users often collaborate on is source code. Thus, source code developers often use version control applications in order to perform complex collaboration.

There are additionally services that host stores (also called “repositories”) that host the text files that individuals are working on. These repositories can be public repositories for documents that the public at large can work on, or private repositories that are restricted in access. Enterprises use private repositories to allow their developers to work on proprietary source code. At the same time, enterprises are concerned that their most important secrets can be leaked into the public sphere.

Accordingly, there exist mechanisms to detect when particular sensitive text is leaked from a private repository into a public sphere. As an example, such sensitive text could include API keys, security certificates, credentials. This text is sensitive because in the wrong hands, the text can be used to provide inappropriate access to services or systems. Accordingly, existing leak detection software is aimed at scan texting to perform secret detection. That is, existing leak detection software detects whether certain text in the public sphere contains sensitive secrets belonging to the enterprise and which are either of a default secret type and/or of a secret type identified by the enterprise.

The subject matter claimed herein is not limited to embodiments that solve any disadvantages or that operate only in environments such as those described above. Rather, this background is only provided to illustrate one exemplary technology area where some embodiments describe herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The principles described herein relate to the computer-performed automatic estimation of data leaks from private stores into public stores. The owner of the data in the private store can then be alerted to the estimation so the cause of such leaks can be remedied. The estimation is based on comparisons between similarity mapping results for data within the private store (the “subject data”) with similarity mapping results for data within the public store (the “comparison data”). Accordingly, even if the data is modified somewhat after it is leaked, the computing system can still detect the likely leak. Furthermore, the system is not limited to searching only for what it thinks is the most sensitive data. Instead, the system looks for any leak of any data.

To prepare for the comparison, the system obtains similarity mapping results of the subject data by, for each of multiple data items in the subject data, obtaining a result of a one-way similarity mapping for the respective data item of the subject data. The one-way similarity mapping is such that similarity in the result implies similarity in input data to the one-way similarity mapping. As an example, the one-way similarity mapping could be a fuzzy hashing or a provenance signature. The system also obtains similarity mapping results of the comparison data by, for each of multiple data items in the comparison data, obtaining a result of the one-way similarity mapping for the respective data item of the comparison data.

The similarity mapping results are then used to estimate that a leak has occurred from the private store to the public store. This is done by comparing similarity mapping results of the subject data. If a similarity mapping result of a particular data item of the comparison data is found that is highly similar to a particular data item of the subject data, the system estimates that this particular data item of the comparison data is highly similar to the particular data item of the subject data. Accordingly, the system estimates that the particular data item of the comparison data is a leaked form of the particular data item of the subject data. Slight alternations of the comparison data do not avoid this estimation. Accordingly, the owner of the subject data may be notified of the estimation so they can remedy the leak and prevent future leaks of their proprietary data.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and details through the use of the accompanying drawings in which:

FIG. 1 illustrates an environment in which a leak detection component detects a leak from a private store to a public store, and in which the principles described herein may operate;

FIG. 2 illustrates an environment that represents an example of the environment of FIG. 1, with various data items now shown as being within the private store and public store;

FIG. 3 illustrates a flowchart of a method for determining that subject data from a private store is similar to comparison data within a public store, in accordance with the principles described herein;

FIG. 4 shows an example process and environment in which similarity mapping results are generated with respect to the example data items of FIG. 3;

FIG. 5 illustrates a flowchart of a method for generating the results of a one-way similarity mapping; and

FIG. 6 illustrates an example computing system in which the principles described herein may be employed.

### DETAILED DESCRIPTION

The principles described herein relate to the computer-performed automatic estimation of data leaks from private stores into public stores. The owner of the data in the private store can then be alerted to the estimation so the cause of such leaks can be remedied. The estimation is based on comparisons between similarity mapping results for data within the private store (the “subject data”) with similarity mapping results for data within the public store (the “comparison data”). Accordingly, even if the data is modified somewhat after it is leaked, the computing system can still detect the likely leak. Furthermore, the system is not limited to searching only for what it thinks is the most sensitive data. Instead, the system looks for any leak of any data.

To prepare for the comparison, the system obtains similarity mapping results of the subject data by, for each of multiple data items in the subject data, obtaining a result of a one-way similarity mapping for the respective data item of the subject data. The one-way similarity mapping is such that similarity in the result implies similarity in input data to the one-way similarity mapping. As an example, the one-way similarity mapping could be a fuzzy hashing or a provenance signature, discussed further below. The system also obtains similarity mapping results of the comparison data by, for each of multiple data items in the comparison data, obtaining a result of the one-way similarity mapping for the respective data item of the comparison data.

The similarity mapping results are then used to estimate that a leak has occurred from the private store to the public store. This is done by comparing similarity mapping results of the subject data. If a similarity mapping result of a particular data item of the comparison data is found that is highly similar to a particular data item of the subject data, the system estimates that this particular data item of the comparison data is highly similar to the particular data item of the subject data. Accordingly, the system estimates that the particular data item of the comparison data is a leaked form of the particular data item of the subject data. Slight alternations of the comparison data do not avoid this estimation. Accordingly, the owner of the subject data may be notified of the estimation so they can remedy the leak and prevent future leaks of their proprietary data.

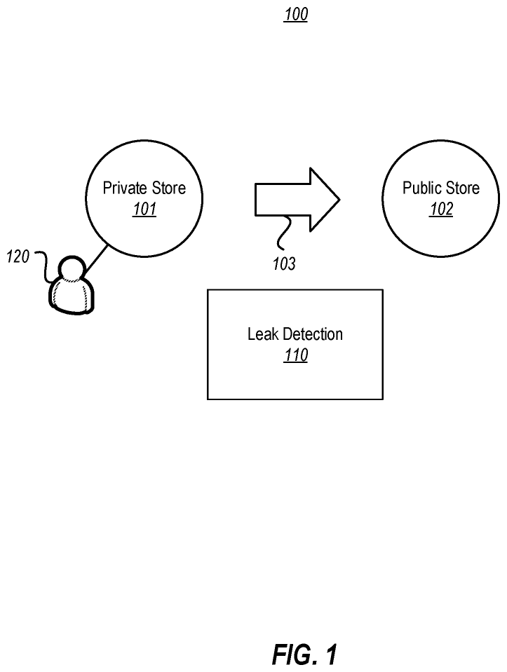

FIG. 1 illustrates an environment 100 in which the principles described herein may operate. The environment 100 includes a private store 101 and a public store 102. The private store 101 holds private data that belongs to an entity 120. That entity 120 could be a user or an organization. On the other hand, the public store 102 holds data that is accessible to entities other than the entity 120. For example, the public store 102 holds data that is accessible more widely and perhaps publicly.

A “store” is any electronic mechanism that persistently stores collections of data items. A store could be a database, a file, a file system, a folder, a directory or any other electronic mechanism that can store collections of data items. A “private” store is a store that is associated with an entity such that an entity or its agents must go through an authentication and authorization process in order to access the data within the private store. A “public” store is a store that is not associated with that entity, and is “public” from the viewpoint of the entity that owns the private data. Thus, a public store is “public” with respect to the entity if authentication and authorization to act on behalf of the entity are not required in order to access the data. A public store may be truly public in that anyone can access the data.

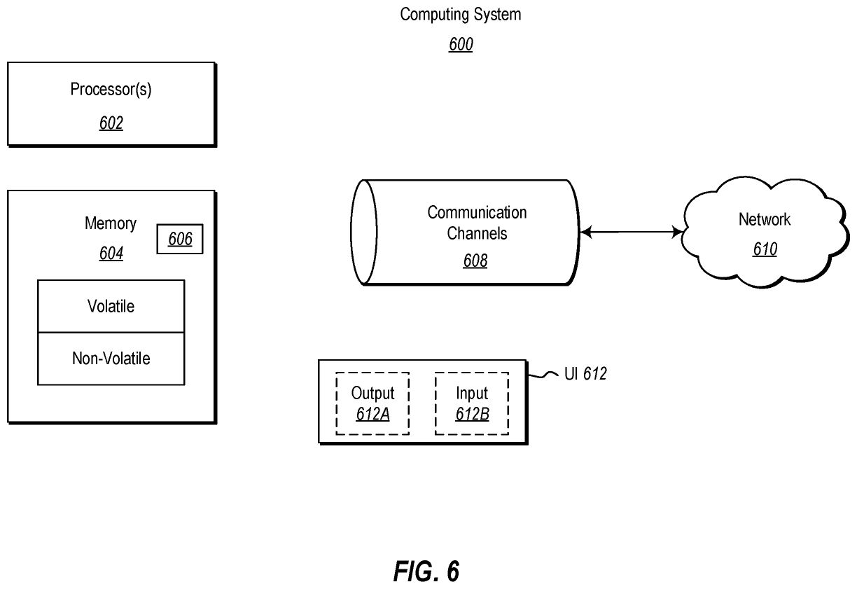

In accordance with the principles described herein, a leak detection component 110 automatically detects that some of the private data from the private store 101 has leaked into the public store 102 even if that data has been modified somewhat after it leaked. Such leakage is represented by arrow 103. The leak detection component 110 may be structured as the computing system 600 described below with respect to FIG. 6. As an example, the computing system 600 is configured to perform the method 100 in response to the at least one processing unit 602 executing computer-executable instructions that are stored in the memory 604. As another example, the leak detection component 110 may be structured as described below for the executable component 606 of FIG. 6.

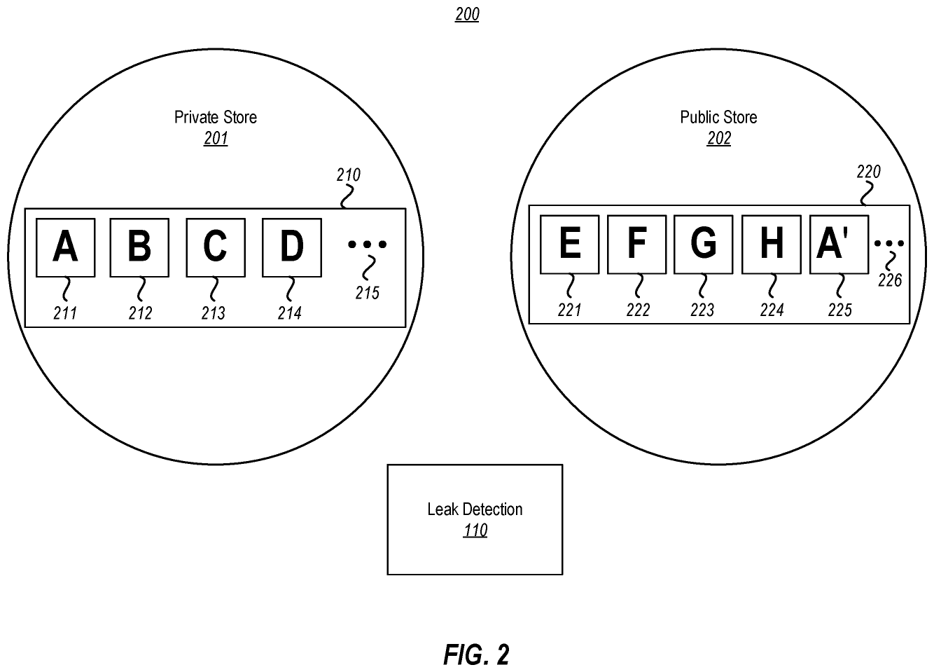

FIG. 2 illustrates an environment 200 that represents an example of the environment 100 of FIG. 1, in which the private store 201 is an example of the private store 101 of FIG. 1, and in which the public store 202 is an example of the public store 102 of FIG. 1. Here, the private store 201 and the public store 202 are illustrated as containing data items. Such data items could be any data, such as perhaps files or functions, or even unstructured data. The private store 201 includes various data items 210 including data items 211 through 214 amongst potentially many more as represented by the ellipsis 215. The public store 202 also includes various data items 220 including data items 221 through 225 amongst potentially many more as represented by the ellipsis 226.

In the illustrated case, the content of each of the data items is represented by an alphabetic character within each data item. For example, with respect to the subject data items 210, data item 211 has content A, data item 212 has content B, data item 213 has content C, and data item 214 has content D. This represents that each of the data items 211 through 214 has different content. Also, with respect to the comparison data items 220, data item 221 has content E, data item 222 has content F, data item 223 has content G, data item 224 has content H, and data item 225 has content A′. This represents that each of the items 221 through 225 has different content. However, this also represents that the content of data item 225 is similar, but not identical, to the content of data item 211. Thus, it is possible that data item 211 has been leaked into the public store 202 and thereafter altered somewhat.

The principles described herein can operate regardless of the type of content in the data item. The data items could contain text (such as source code or other text document), or perhaps could be binary. As an example, the data items 210 can be a codebase.

The number of data items is kept relatively small in the example of FIG. 2 for purposes of clarity. In reality, a typical store can contain dozens, hundreds, thousands, millions, or even billions of data items depending on the nature of the store and data items. The principles described herein are not limited to the type of store or data items. Regardless, the principles described herein related to the automated estimation when a data item has leaked from the private store to a public store. In this description and in the claims, the data within the private store will often be referred to as “subject data” which is the data that is subject to be protected. The data within the public store will often be referred to as “comparison data”. Accordingly, the data 210 is as example of subject data, and the data 220 is an example of comparison data.

The principles described herein do not compare the subject data directly to the comparison data. Accordingly, there is no requirement that the leak detection component 110 have direct access to the subject data or the comparison data, although in some embodiments that is the case. Thus, in some embodiments, the entity 120 retains privacy over their private data even from the computing system that is to evaluate whether a leak has occurred. This is done by comparing similarity mapping results of the subject data and the comparison data, rather than by directly comparing the subject data and comparison data. To facilitate this embodiment, the leak detection component 110 would have its own data store which is independent of the private data store 101. The entity 120 would perform the one-way similarity mapping and communicate the collection of similarity mapping results for that private data to the leak detection component 120.

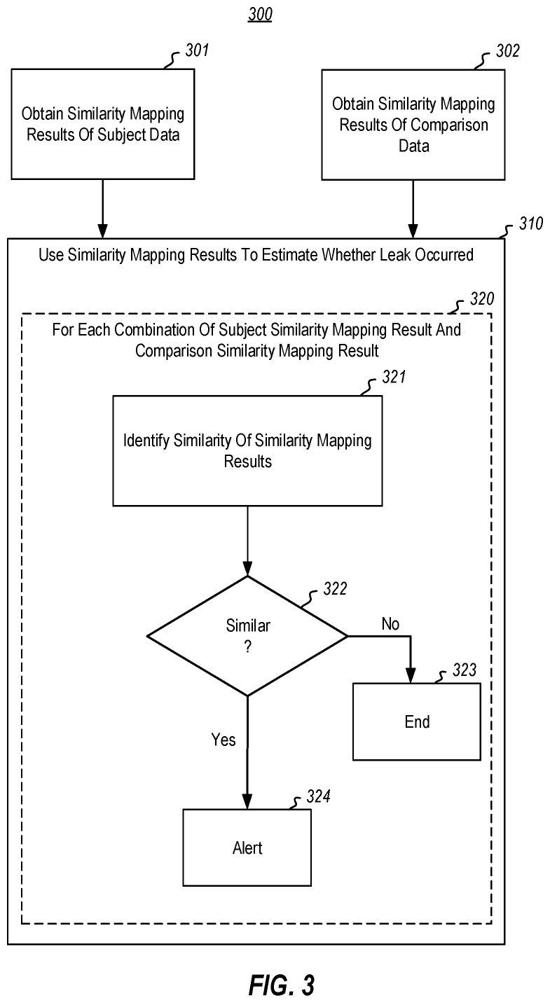

FIG. 3 illustrates a flowchart of a method 300 for determining that subject data from a private store is similar to comparison data within a public store, in accordance with the principles described herein. Referring to FIG. 1, the leak detection component 110 performs the method on subject data from the private store 101 and the comparison data from the public store 102.

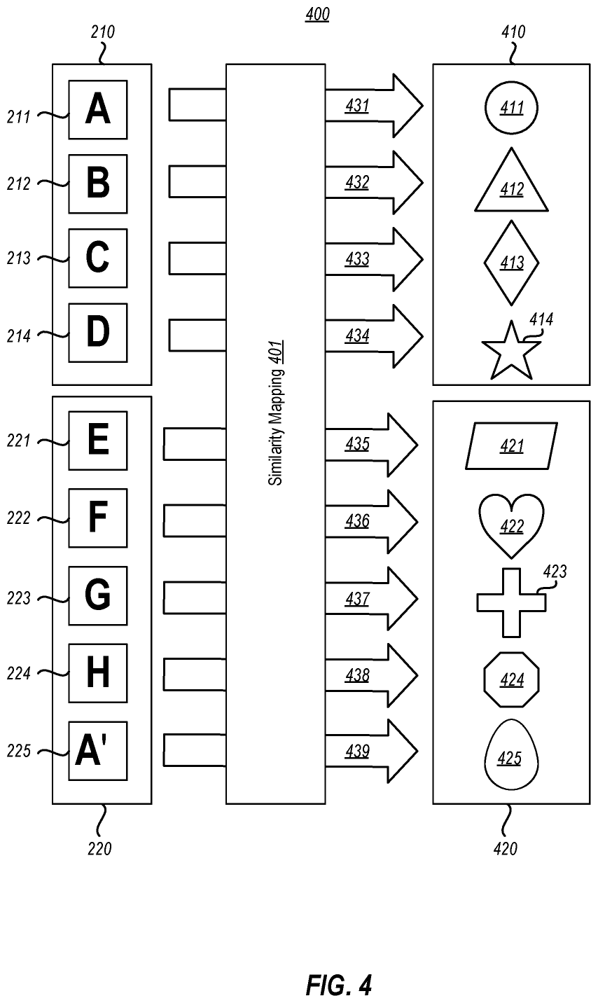

To prepare for this comparison, the leak detection component 110 obtains similarity mapping results of the subject data (act 301). In addition, the leak detection component 110 obtains similarity mapping results of the comparison data (act 302). FIG. 4 shows an example process and environment 400 in which similarity mapping results are generated with respect to the example data items 211 through 214, and 221 through 225 of FIG. 2.

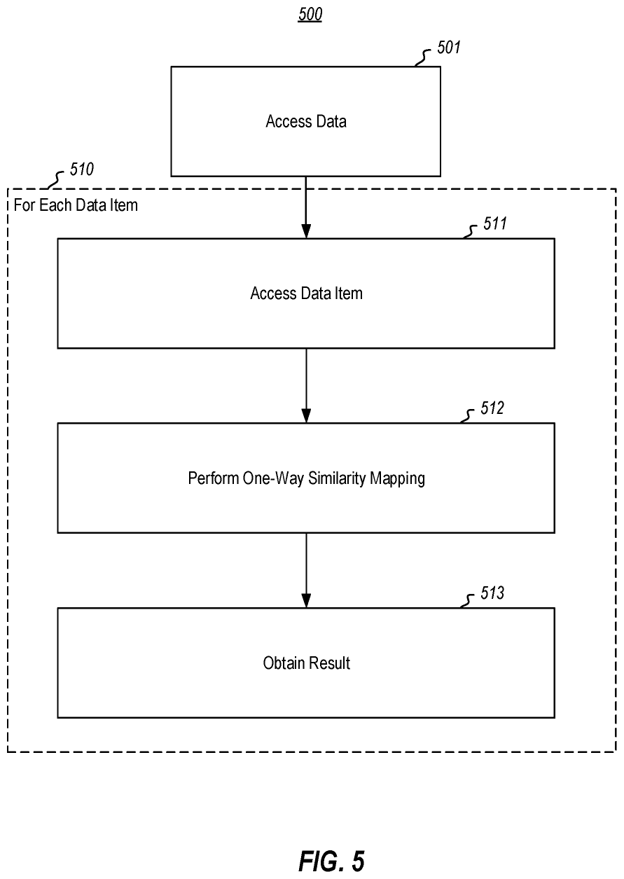

Referring to FIG. 4, a one-way similarity mapping algorithm 401 is applied to each of the data items 210 of the subject data in order to obtain results 410. FIG. 5 illustrates a flowchart of a method 500 for generating the results of a one-way similarity mapping. The method 500 includes access the subject data itself (act 501). As an example, in FIG. 4, the subject data 210 is accessed. Furthermore, for each of the data items (e.g., data items 211 through 214) of the subject data, the content of box 510 is performed. Specifically, the data item is accessed (act 511), and the one-way similarity mapping 401 is applied to that data item (act 512) to generate the result (act 513). In the example of FIG. 3, the similarity mapping 401 is applied (as represented by arrow 431) to data item 211 to obtain result 411, is applied (as represented by arrow 432) to data item 212 to obtain result 412, is applied (as represented by arrow 433) to data item 213 to obtain result 413, and is applied (as represented by arrow 434) to data item 214 to obtain result 414.

The one-way similarity mapping algorithm is also applied to each of the data items 220 of the comparison data in order to obtain results 420. FIG. 5 also is applied to the comparison data. That is, the similarity mapping is applied (as represented by arrow 435) to data item 221 to obtain result 421, is applied (as represented by arrow 236) to data item 222 to obtain result 422, is applied (as represented by arrow 437) to data item 223 to obtain result 423, is applied (as represented by arrow 438) to data item 224 to obtain result 424, and is applied (as represented by arrow 439) to data item 225 to obtain result 425.

The one-way similarity mapping is such that similarity in the result implies similarity in the input data. In the nomenclature of FIGS. 2 and 4, the uniqueness and similarity of the content of the input data items 211 through 214, and 221 through 225 is represented by the similarity between the letter shown within the data item. Thus, data items 211 through 214, and 221 through 224 have unique non-similar content. On the other hand, data items 211 and 225 have similar content with the data item 225 being somewhat altered. In the nomenclature of FIG. 4, the uniqueness and similarity of the results 411 through 414, and 421 through 425 is represented by the similarity between the shape of the result. Thus, results 411 through 414 and 421 through 424 are results that are not similar at all as symbolized by each being a different shape. However, result 411 (represented as a circle) is quite similar to result 425 being represented by a similar shape—an egg shape.

The one-way similarity mapping 401 is such that the similarity in the results 411 and 425 implies similarity of the input data items 211 and 225. Examples of one-way similarity mappings include fuzzy hashing such as is available in ssdeep. Another example of similarity mappings is provenance signatures, such as the provenance signatures described in U.S. Pat. Publication No. 2019/02005125. Similarity mappings may also be weighted combinations of other similarity mappings. For example, similarity mappings may be performed on both functions and files, with the similarity of the result for functions having a different weighting than the results for files. As an additional example, fuzzy hashing and provenances signature generation may both be performed, with the similarities of each being weighted to determine a final similarity. Provenance signatures can be used on text files, while fuzzy hashing can be used on all types of data, including both binary and text files.

The one-way similarity mapping also has the property that the original input data items cannot be generated from the result of the mapping—as it is a many-to-one mapping. Accordingly, the method 300 may be performed in a way to allow the subject data to remain private if the leak detection component obtains only the results of the one-way similarity mapping, and does not ever access the subject data. On the other hand, if confidentiality of the subject data is not a concern, the leak detection component 110 can itself perform the method 500 on the subject data by directly accessing the subject data. Alternatively, or in addition, the method 300 may be performed in a way to allow the comparison data to remain private if the leak detection component obtains only the results of the one-way similarity mapping, and does not ever access the comparison data. On the other hand, if confidentiality of the comparison data is not a concern, the leak detection component 300 can itself perform the method 500 on the comparison data.

The results of the similarity mapping may be obtained (act 301 and act 302) at anytime prior to comparing those similarity mappings. For data that does not change often, the similarity mappings may be generated well in advance. In any case, returning to FIG. 3, the similarity mapping results are then used to estimate that a leak has occurred from the private store to the public store (act 310).

For each combination of subject similarity mapping result and comparison similarity mapping result, the content of box 320 is performed with respect to the applicable subject similarity mapping result and the applicable comparison similarity mapping result. First, a similarity level is identified corresponding to a similarity between the respective subject similarity mapping result (act 321). Take the case of the subject similarity mapping result 411 and the comparison similarity mapping result 421 in FIG. 4. In that case, the similarity level is low (“No” in decision block 322) and thus the content of box 320 completes (act 323) with respect to that combination of results. The same is true comparing any of the subject similarity mapping results 412 through 414 with any of the comparison similarity mapping results 421 through 425. Furthermore, the same is true comparing the subject similarity mapping result 411 with the comparison similarity mapping results 421 through 414.

However, when comparing the subject similarity mapping result 411 with the comparison similarity mapping result 425, the similarity level is high (“Yes” in decision block 322). Accordingly, based on the comparison, the leak detection component determines that the particular similarity mapping result 411 of the subject data is similar to a particular similarity mapping result 424 of the comparison data (act 324). In response to this determination (act 324), the leak detection component alerts an administration computing system of the private store that data from the private store is estimated to have been leaked into a public store (act 324). The leak detection component may also provide the subject data item 211 and the comparison data item 225 so that the enterprise can examine the two data items to see if they think the comparison data item 225 represents a leaked form of the subject data 211.

In some embodiments, the leak detection component first determines that the subject similarity detection result is not for a data item that originated in the public sphere. As an example, it may be that perhaps an enterprise is using open source as a component in their proprietary code. If the leak detection component does not account for this possibility, the leak detection component may generate false alerts as it finds copies of that open source without the public sphere. Of course, it is entirely appropriate that open source be within the public sphere. The leak detection component may use provenance signatures in order to detect whether the subject source code originated in the public sphere, and thus should not be evaluated under method 300.

In addition, even if the subject data item did not originate in the public sphere, the enterprise owning the subject data item may have dedicated the data item to the public. Accordingly, the leak detection component may also determine (e.g., based on enterprise input) whether the subject data item has likely been dedicated to the public intentionally. Evaluation of method 300 may also be avoided for such subject data.

The principles described herein are not limited to the frequency with which the leak detection evaluates subject data items against comparison data items. In one embodiment, the leak detection check is performed in response to evaluating an activity log of the enterprise to identify activity indicative of a potential leak, such as a copy operation copying data from a private store to a public store, or the redesignation of a private store as a public store. If potential leaking activity is observed, this could trigger the performance of the method 300.

Accordingly, the principles described herein permit for the automated estimation that leak has occurred from a private store to a public store. Because the principles described herein are performed in the context of a computing system, some introductory discussion of a computing system will be described with respect to FIG. 6. Computing systems are now increasingly taking a wide variety of forms. Computing systems may, for example, be handheld devices, appliances, laptop computers, desktop computers, mainframes, distributed computing systems, data centers, or even devices that have not conventionally been considered a computing system, such as wearables (e.g., glasses). In this description and in the claims, the term “computing system” is defined broadly as including any device or system (or a combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 6, in its most basic configuration, a computing system 600 includes at least one hardware processing unit 602 and memory 604. The processing unit 602 includes a general-purpose processor. Although not required, the processing unit 602 may also include a field programmable gate array (FPGA), an application specific integrated circuit (ASIC), or any other specialized circuit. In one embodiment, the memory 604 includes a physical system memory. That physical system memory may be volatile, non-volatile, or some combination of the two. In a second embodiment, the memory is non-volatile mass storage such as physical storage media. If the computing system is distributed, the processing, memory and/or storage capability may be distributed as well.

The computing system 600 also has thereon multiple structures often referred to as an “executable component”. For instance, the memory 604 of the computing system 600 is illustrated as including executable component 606. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods (and so forth) that may be executed on the computing system. Such an executable component exists in the heap of a computing system, in computer-readable storage media, or a combination.

One of ordinary skill in the art will recognize that the structure of the executable component exists on a computer-readable medium such that, when interpreted by one or more processors of a computing system (e.g., by a processor thread), the computing system is caused to perform a function. Such structure may be computer readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hard coded or hard wired logic gates, that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data. If such acts are implemented exclusively or near-exclusively in hardware, such as within a FPGA or an ASIC, the computer-executable instructions may be hard-coded or hard-wired logic gates. The computer-executable instructions (and the manipulated data) may be stored in the memory 604 of the computing system 600. Computing system 600 may also contain communication channels 608 that allow the computing system 600 to communicate with other computing systems over, for example, network 610.

While not all computing systems require a user interface, in some embodiments, the computing system 600 includes a user interface system 612 for use in interfacing with a user. The user interface system 612 may include output mechanisms 612A as well as input mechanisms 612B. The principles described herein are not limited to the precise output mechanisms 612A or input mechanisms 612B as such will depend on the nature of the device. However, output mechanisms 612A might include, for instance, speakers, displays, tactile output, virtual or augmented reality, holograms and so forth. Examples of input mechanisms 612B might include, for instance, microphones, touchscreens, virtual or augmented reality, holograms, cameras, keyboards, mouse or other pointer input, sensors of any type, and so forth.

Embodiments described herein may comprise or utilize a special-purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special-purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special-purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmission media can include a network and/or data links which can be used to carry desired program code means in the form of computer-executable instructions or data structures and which can be accessed by a general-purpose or special-purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then be eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general-purpose computing system, special-purpose computing system, or special-purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing system, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicate by the appended claims rather than by the foregoing description. All changes which come within the meaning and range of equivalency of the claims are to be embraced within their scope.

What is claimed is:

1. A computing system for determining that subject data from a private store is similar to comparison data within a public store and alerting that a leak is estimated to have occurred, the computing system comprising:
one or more processors; and
one or more computer-readable media having thereon computer-executable instructions that are structured such that, if executed by the one or more processors, the computing system is configured to:
obtain a plurality of similarity mapping results of the subject data by, for each of a plurality of data items in the subject data, obtaining a result of a one-way similarity mapping for the respective data item of the subject data, the one-way similarity mapping being such that similarity in the result implies similarity in input data to the one-way similarity mapping;
obtain also a plurality of similarity mapping results of the comparison data by, for each of a plurality of data items in the comparison data, obtaining a result of the one-way similarity mapping for the respective data item of the comparison data;
use the similarity mapping results to estimate that a leak has occurred from the private store to the public store, comprising:
for at least a particular similarity mapping result of the plurality of similarity mapping results of the subject data, identify a similarity level between the particular similarity mapping result of the subject data and each of at least some of the plurality of similarity mapping results of the comparison data; and
based on the comparison, determine that the particular similarity mapping result of the subject data is similar to a particular similarity mapping result of the comparison data; and
in response to the determination. alert an administration computing system of the private store that data from the private store is estimated to have been leaked into a public store.

2. The computing system in an accordance with claim 1, the obtaining of the plurality of similarity mapping results of the subject data comprising:
accessing the subject data itself;
obtaining the plurality of data items from the subject data;
for each of the plurality of data items, applying the one-way similarity mapping to each of the plurality of data items.

3. The computing system in an accordance with claim 1, the obtaining of the plurality of similarity mapping results of the subject data comprising:
obtaining the plurality of similarity mapping results only after having been subject to the one-way similarity mapping such that confidentiality of the subject data is preserved even from a computing system performing the method.

4. The computing system in accordance with claim 1, further comprising:
evaluating a log to identify activity indicative of data being leaked from the private store, the acts of using the similarity mapping results to estimate that a leak has occurred from the private store to the public store occurring in response to the identification of activity indicative of data being leaked.

5. The computing system in accordance with claim 1, wherein using the similarity mapping results to estimate that a leak has occurred from the private store to the public store further comprises:
determining that the particular similarity result is for a data item of the subject data that did not originate in public.

6. A method for determining that subject data from a private store is similar to comparison data within a public store, the method comprising:
obtaining a plurality of similarity mapping results of the subject data by, for each of a plurality of data items in the subject data, obtaining a result of a one-way similarity mapping for the respective data item of the subject data, the one-way similarity mapping being such that similarity in the result implies similarity in input data to the one-way similarity mapping;
obtaining also a plurality of similarity mapping results of the comparison data by, for each of a plurality of data items in the comparison data, obtaining a result of the one-way similarity mapping for the respective data item of the comparison data;
using the similarity mapping results to estimate that a leak has occurred from the private store to the public store, comprising:
for at least a particular similarity mapping result of the plurality of similarity mapping results of the subject data, identifying a similarity level between the particular similarity mapping result of the subject data and each of at least some of the plurality of similarity mapping results of the comparison data; and
based on the comparison, determining that the particular similarity mapping result of the subject data is similar to a particular similarity mapping result of the comparison data; and
in response to the determination. alerting an administration computing system of the private store that data from the private store is estimated to have been leaked into a public store.

7. The method in an accordance with claim 6, the obtaining of the plurality of similarity mapping results of the subject data comprising:
accessing the subject data itself;
obtaining the plurality of data items from the subject data;
for each of the plurality of data items, applying the one-way similarity mapping to each of the plurality of data items.

8. The method in an accordance with claim 6, the obtaining of the plurality of similarity mapping results of the subject data comprising:
obtaining the plurality of similarity mapping results only after having been subject to the one-way similarity mapping such that confidentiality of the subject data is preserved even from a computing system performing the method.

9. The method in accordance with claim 6, the one-way similarity mapping comprising fuzzy hashing.

10. The method in accordance with claim 6, the one-way similarity mapping comprising provenance signature generation.

11. The method in accordance with claim 6, the one-way similarity mapping comprising a combination of provenance signature generation and fuzzy hashing.

12. The method in accordance with claim 6, each of at least some of the data items of the subject data being a respective file of the subject data.

13. The method in accordance with claim 6, each of at least some of the data items of the subject data being a respective function of the subject data.

14. The method in accordance with claim 6, each of at least some of the data items of the subject data being binary data.

15. The method in accordance with claim 6, each of at least some of the data items of the subject data being text data.

16. The method in accordance with claim 6, each of at least some of the data items of the subject data being source code.

17. The method in accordance with claim 6, further comprising:
evaluating a log to identify activity indicative of data being leaked from the private store, the acts of using the similarity mapping results to estimate that a leak has occurred from the private store to the public store occurring in response to the identification of activity indicative of data being leaked.

18. The method in accordance with claim 6, wherein using the similarity mapping results to estimate that a leak has occurred from the private store to the public store further comprises:
determining that the particular similarity result is for a data item of the subject data that did not originate in public.

19. The method in accordance with claim 6, wherein using the similarity mapping results to estimate that a leak has occurred from the private store to the public store further comprises:
determining that the particular similarity result is for a data item that has not been dedicated for public use.

20. A computer program product comprising one or more computer-readable media having thereon computer-executable instructions that are structured such that, when executed by one or more processors, the computing system is configured to:
obtaining a plurality of similarity mapping results of the subject data by, for each of a plurality of data items in the subject data, obtaining a result of a one-way similarity mapping for the respective data item of the subject data, the one-way similarity mapping being such that similarity in the result implies similarity in input data to the one-way similarity mapping;
obtaining also a plurality of similarity mapping results of the comparison data by, for each of a plurality of data items in the comparison data, obtaining a result of the one-way similarity mapping for the respective data item of the comparison data;
using the similarity mapping results to estimate that a leak has occurred from the private store to the public store, comprising:
for at least a particular similarity mapping result of the plurality of similarity mapping results of the subject data, identifying a similarity level between the particular similarity mapping result of the subject data and each of at least some of the plurality of similarity mapping results of the comparison data; and
based on the comparison, determining that the particular similarity mapping result of the subject data is similar to a particular similarity mapping result of the comparison data; and
in response to the determination. alerting an administration computing system of the private store that data from the private store is estimated to have been leaked into a public store.
